(19) United States
(12) Patent Application Publication
(10) Pub. No.: US 2016/0201853 A1
(43) Pub. Date: Jul. 14, 2016

(54) FILLING DEVICE FOR A SORPTION STORE AND SORPTION STORE

(71) Applicant: BASF SE, Ludwigshafen (DE)

(72) Inventors: Matthias WEICKERT, Ludwigshafen (DE); Stefan MARK, Dirmstein (DE); Ulrich MÜLLER, Neustadt (DE); Peter RENZE, Mannheim (DE)

(21) Appl. No.: 14/911,756

(22) PCT Filed: Aug. 11, 2014
(86) PCT No.: PCT/IB2014/063842

§ 371 Date: Feb. 12, 2016

(30) Foreign Application Priority Data
Aug. 15, 2013 (EP) 13180518.6

(51) Int. Cl. F17C 11/00; F17C 5/06

(52) U.S. Cl. CPC F17C 11/007; F17C 5/06; F17C 2221/033; F17C 2260/023; F17C 2270/0168

(57) ABSTRACT

Filling device (22) for an ANG-sorption store (10) containing at least one adsorption medium (20), said filling device (22) being of tubular shape, having a mantle (36) defining a hollow interior, orifices (48) in said mantle (36), said ANG-sorption store (10) substantially mounted horizontally, wherein said orifices (48) are arranged on an upper part (62) of said mantle (36) of the filling device (22) extending in axial direction (34) through said ANG-sorption store (10).

The present invention relates to a sorption store or a sorption vessel. Adsorbed Natural Gas (ANG) has the potential to replace compressed natural gas in mobile storage applications such as in vehicles. Although a substantial research effort has been devoted to ANG, very few studies evaluate the impact of heat of adsorptions on system performance. In turn, in ANG-applications a micro powder solid, such as activated carbon, is packed in a vessel to increase the storage density, enabling lower pressure operation with the same capacity. Adsorption is an exothermic process. Any adsorption or desorption is accompanied by temperature change in an ANG-storage system. The heat of adsorption has a detrimental effect on performance during both charge- and discharge cycles. A temperature increase as high as 80° C. can occur during the charge cycle. A charge cycle normally will be performed in a fuel station, at least for mobile applications, where the released adsorption heat can be removed. Contrary to the charge cycle, the rate of discharge is dictated by the energy demand of the application. This charge time cannot be widely varied to moderate the impact of cooling during the use of ANG storage vessels. It is also not feasible to include excessive hardware to moderate the temperature in a mobile application.

US 2007/180998 A1 is related to an apparatus for optimal adsorption and desorption of gases utilizing high porous gas storage materials. An apparatus for separately adsorbing gas during adsorption processes and desorbing gas during sorption processes is disclosed. A tube is equipped with a porous sidewall and at each end an end-fitting sealingly connected is connected thereto. A particulate porous gas storage material is located within the tube, wherein the porosity prevents the material, but allows gases, to pass therethrough. A selected gas from a porous tube, a heating coil or a heat exchanger located within the tube, may provide heat for the desorption processes and the selected gas or heat exchanger may provide cooling during the adsorption processes.

US 2008/0290645 A1 is related to shaped absorbent media installed in a high-pressure tank. An absorbent medium suitable for gas or heat is provided in a predetermined length or is provided in a pre-determined length of a polygon or a curvilinear, and preferably a honeycomb (hexagonal) cross-sectioned shape with gas absorbent media packed therein. The hexagonal tubes may be installed along the radial or longitudinal axis of a fuel tank. The media and/or media tubes are installed during tank manufacture and include defined physical and gas circulation relationships for maintaining extending tubes having a gas absorbent medium therein in a predetermined interrelationship with adjacent spaces of similar shape that are either open, or filled with a heat absorbent medium.

WO 2009/071436 A1 is related to a method for storing gaseous hydrocarbons. Gaseous hydrocarbons are stored in a sorption reservoir. The temperature of the stored hydrocarbons when the sorption reservoir is full, is lower than room temperature and higher than the evaporation temperature of the hydrocarbon. This solution also relates to a device for storing gaseous hydrocarbons, comprising a sorption reservoir that is isolated in relation to the surroundings. The sorption reservoir contains zeolite, activated carbons or metal-organic framework compounds.

US 2009/0261107 A1 is related to a motor vehicle with a gas tank. The vehicle powered by a fuel cell system and/or an internal combustion engine and having at least one gas tank for being filled with a gaseous fuel, in particular with natural gas or hydrogen, wherein a metal organic framework (MOF) is arranged in the interior of the gas tank as a storage material for holding the fuel is disclosed. A comparatively high storage density is obtained and/or sufficient space for luggage or loading is made available in the vehicle. This is achieved according to US 2009/0261107 A1 in that the gas tank which comprises the metal organic framework (MOF) is embodied as a compressed-gas tank for storing the gaseous fuel under pressure.

US 2012/0308944 A1 discloses a method of manufacturing a perforated pipe for a gas generator as well as a gas generator. A method of manufacturing a perforated pipe for a gas generator is disclosed, including a pipe-like member forming step of forming a closed-bottom pipe-like member from a plate-like member by press-forming using a rod-like member and a mold. A hole punching step follows inserting a die into the pipe-like member in place of the rod-like member, the die including one or more through holes in a direction intersecting an axial direction thereof, and punching through the pipe-like member formed in the pipe-like member forming step with a punching member aligned with a position of each through hole to form one or more pairs of opposed punch holes. A distance between the paired punch holes is any value selected from 3 mm to 10 mm, respectively.

In the solutions of the prior art a problem is given which is caused by the substantially horizontal mounting of the sorption reservoir, such as an ANG-tank. Due to the generated adsorption heat, the adsorption reservoir heats up which decreases the inductivity in terms of heat of the pellets-shaped sorption material resulting in a decreased capacity of pellets of metal organic framework (MOF) to give an example. Intentionally perforated pipes disclosed in US 2007/180998 A1 or according to US 2012/0308944 A1 vary due to gravity and due to density differences between hot and cold gases in an inhomogeneous distribution of temperature fluid dynamics. Hot gas tends to move in vertical direction to the top of the sorption reservoir, whereas colder gas tends to move—due to gravity and its higher density—to the bottom of the adsorption reservoir.

Due to the problems encountered in the technical field, it is an object of the present invention, to create a homogeneous distribution of fluid dynamic with an ANG-storage reservoir which substantially lowers the charging time required for the charging cycle of an adsorption reservoir, particularly for vehicle applications.

### SUMMARY OF THE INVENTION

Due to the problems encountered in the technical field, it is an object of the present invention, to create a homogeneous distribution of fluid dynamics with an ANG-sorption store which substantially lowers the charging time required for the charging cycle of an adsorption reservoir, particularly for vehicle applications.

According to the present invention, a filling device for a sorption store containing at least one adsorption medium, for example metal organic frame work (MOF), of tubular shape and having a mantle defining a hollow interior comprises orifices within that mantle, the sorption store substantially mounted horizontally, wherein said orifices may be arranged on an upper part of the filling device. Alternatively, said orifices are arranged on said filling device in circumferential direction, however leaving an area at the bottom of said filling device free of orifices, for instance within an angle of 30° up to 180° of the circumference of said mantle of the filling device, preferably about 120°. These angles may vary dependent on the porosity of the at least one adsorption medium. The porosity is defined as ratio of the hollow space between the at least one adsorption medium in the shape of pellets divided to the entire hollow interior of the sorption store.

From said mantle, the filling device is extending in axial direction through said sorption reservoir.

Since only the upper part of said filling device is provided with orifices and the lower part of the circumference of said filling device is closed within an angle of 30° to 180°, preferably 120°, no gas jets of hydrocarbons, such as methane (CH₄) or another natural gas, are emitted in direction to the bottom of said ANG-sorption store, which is arranged in substantially horizontal direction. Jets only are emitted into the upper part of the interior of said ANG-sorption store, thus, a uniform temperature distribution within the adsorption material, such as MOF, which is present in the interior of said ANG-sorption store, is achieved. The main effect of the solution according to the invention is the increase of heat conductivity of the MOF-pellets from the center thereof into the peripheral areas, which are subject to an external cooling of the circumference of said ANG-sorption store.

According to the present invention, said orifices are arranged on said mantle of the filling device in axial direction. Very beneficial is the arrangement of said orifices beginning with a third or two thirds of the entire length of the tubular-shaped filling device. Very good results are achieved in having said orifices arranged starting from the half length of said filling device in an axial direction thereof, however, not on the lower surface area on the circumference of the said filling device within an angle of 30° to 180°, preferably 120°.

A further advantageous embodiment is given by orifices which are arranged equidistant with respect to one another, seen in axial direction of said tube-like filling device. Said orifices may be arranged on the upper part of said filling device in rows, said rows being arranged equidistant with respect to one another on the surface of the filling device. The number of orifices varies between 3, 4 or 7 in a uniform or non-uniform distribution of each row in circumferential direction of said upper part. Said orifices may be machined as holes or as slots, the slots extending in axial direction of the mantle defining the hollow interior of said filling device, slot-shaped orifices are not present as well on the lower part of the circumference of said filling device within an angle of 30° to 180°, preferably within an angle of about 120°. Said filling device, having a substantially tubular shape, is fastened on one end face of said ANG-sorption store having a substantially cylindrical configuration.

The orifices arranged along the circumference of the upper part of said filling device may have an identical geometry. In the present context it is meant that said orifices, regardless whether manufactured as holes or as slots, are identical with respect to diameter and are identical with respect to the slot length, the slots extending in axial direction of the filling device.

Alternatively, the filling device may comprise orifices, which are arranged in axial direction of the filling device, i.e. on said mantle thereof and which may have a varying diameter. This means that said orifices arranged in equidistance or non-equidistance in axial direction of said filling device may have continuously decreasing diameters or may have—seen in axial direction of the filling device—varying diameters, i.e. increasing diameters, particularly starting from the half of the length of the tube-like shaped filling device. Instead of having the orifices arranged equidistantly on the surface of the upper part of the filling device, said orifices may be arranged in varying distances, i.e. distances in axial direction decrease or increase with respect to the ends, i.e. the tip of said tubular-shaped filling device. In this context, orifices are not present along a lower part of the circumference of the filling device according to the present invention within an angle of 30° to 180°, preferably about 120° of the lower circumference.

Regardless, whether those orifices are manufactured as holes, particularly by drilling operation, or as slots, particularly by a drilling or sawing operation, the upper part of said filling device orifice patterns are created. Said patterns may be arranged as patterns of holes or patterns of slots, said orifices having an identical geometry or may have a varying geometry in terms of diameter or slot-length, respectively. In said pattern arrangement on the surface of the upper half of the filling device, said orifices may have an offset with respect to one another with respect of orifices arranged in adjacent rows along the circumference of said upper shell of the filling device. The present invention also discloses a sorption store, i.e. an ANG-sorption store which contains at least one adsorption material, such as metal organic framework (MOF), which is equipped with a filling device as described heretofore. Said ANG-sorption store has a substantially cylindrical shape and is mounted in horizontal direction. In a preferred embodiment, the filling device is arranged within said ANG-sorption store in the center access thereof, so that the surface of the tubular-shaped filling device is equidistant with respect to the inner walls, defining ANG-sorption store.

Since only the upper part of said filling device is provided with orifices and the lower part of the circumference of said filling device is closed within an angle on the circumference of about 30° to 180°, preferably 120°, no gas jets of hydrocarbons, such as methane (CH₄) or another natural gas are emitted in direction to the bottom of said ANG-sorption store, which is arranged in substantially horizontal direction. Jets only are emitted into the interior of said ANG-sorption store, so no uniform heat distribution within the adsorption material, such as MOF, which is present in the interior of said ANG-sorption store, can be achieved. The main effect of the solution according to the invention is the increase of heat conductivity of the MOF-pellets from the center thereof into the peripheral areas, which are subject to an external cooling on the circumference of said ANG-sorption store.

Benefits of the Invention

By implementing the present filling device into an ANG-sorption store, the time required for a charging cycle at a fuel station is lowered by about 30%, since an even, homogeneous distribution of fluid dynamics within an ANG-sorption store is achieved as well as an improvement in terms of a homogeneous temperature distribution within the ANG-sorption store. The present invention can be implemented in larger ANG-sorption store for transport vehicles, such as trucks, and in further embodiments, the filling device having an open-end section, no orifices on the circumference thereof, but instead a bent end section can be implemented into smaller ANG-sorption store for use in passenger vehicles. The implementation of the present invention in an ANG-sorption store advantageously eliminates disadvantageous effects due to gravity, since no gas jets are ejected into the bottom of the sorption store, i.e. in the direction of the adsorption material present in the ANG-sorption store at the bottom thereof. This contributes to a more even temperature distribution within the sorption store which has a positive effect on the charging time when natural gas, such as CH₄, H₂ or the like is circulated through the sorption store. By circulating the natural gas, the temperature within the interior of the sorption store is lowered. At lower temperatures, more natural gas can be absorbed by the at least one sorption medium, so that the maximum mass of gas can be filled through the sorption store in a shorter period of time.

Still further, the metal organic frameworks (MOF) are not subject to wear, since due to the cooling sketched above, local hot spots in the MOF-material are avoided, so that the duration and the storage capacity of the metal organic framework is enhanced. Still further, the wall of the sorption store is less subjected with undue temperature variations. A sorption store wall manufactured from carbon fibers is subject to premature failure, particularly the liner thereof at temperatures of more than 80° C.

Upon implementation of the circulation of the natural gas through the sorption store, an outlet can be arranged in the part of the sorption store, where the inlet is arranged. In this case advantageously only the last three quarters preferably half of the tube-shaped filling device is to be perforated, i.e. is to be shaped having orifices. Additionally, the axial distance of the orifices may be decreased in direction to the tip, i.e. the end of the tube-shaped filling device, or further, the diameter of the orifice may increase in direction to the end of the tube-shaped filling device. Particularly for applications in passenger vehicles, where less room is available, the end portion of said tube-shaped filling device is bent into an upper direction. The bending angle preferably is chosen with 30° and 90° preferably by 65°. In this case, said filling device has an outlet only at the end of the tube-shaped body of the filling device.

In case an outlet is arranged opposite in that, the orifices of the filling device should have different sizes. Alternatively, the distance seen in axial direction of the orifices may increase in direction to the outlet. Given an equal distance between the orifices arranged on the outer circumference of the tube-shaped filling device, however, an upper portion of the circumference between 30° to 180°, preferably about 120°, being substantially orifice-free, said orifices are larger about factor 10, preferably about factor 2 between the uppermost and the lowermost orifice in the tubular-shaped filling device.

On a normal filling cycle, given a porosity between 0.3 and 0.5, the distance between the orifices preferably should decrease in axial direction about factor 7, provided the size of the orifice remains equal. Given higher porosities, i.e. larger than 0.5, the orifice distance should decrease about a factor in between 1 to 7. Provided that lower porosities, i.e. porosities of less than 0.3, the distance between the orifices should decrease in between the factor 7 to 10.

With respect to the inlet and outlet of the sorption store according to the present invention, the cross-section of the inlet should equal to be identical.

It is worthwhile mentioning that the size of the orifices should be chosen to be less than the size of the pellets, so that an entry of pellets to the hollow interior of the tubular-shaped orifice is prevented. The size of the orifices, particular in the circular shape, is to be chosen advantageously within 0.5 mm to 3 mm.

In an embodiment of the invention, the at least one vessel is a pressure vessel for the storage of gas at a pressure in the range up to 500 bar, preferably in a range of 1 bar to 400 bar, most preferably in a range of 1 bar to 250 bar and in particular preferably in a range of 1 bar to 100 bar.

### BRIEF DESCRIPTION OF THE DRAWINGS

The present invention is described in more detail by the accompanying drawings.

FIG. 1 shows a first embodiment of an ANG-sorption store with an inlet and an outlet,

FIG. 2 shows an embodiment of an ANG-sorption store with a circulation circuit, including a heat exchanger and a compressing means,

FIG. 3 in greater details shows an embodiment of a tubular-shaped filling device with gas jets injected into the upper half of the ANG-sorption store,

FIG. 4 shows a first cross-section through the filling device according to FIG. 3,

FIG. 5 shows a second cross-section through the filling device according to FIG. 3,

FIG. 6 shows an embodiment of the filling device according to the present invention having a bent section,

FIG. 7 shows an orifice pattern in top view on the upper half of the filling device, said orifices being holes,

FIG. 8 shows an embodiment of a slot-like pattern on the surface of the upper half of the filling device according to the present invention and

FIG. 9 shows an embodiment of an ANG-sorption store with an inlet and an outlet on the same end face.

### PREFERRED EMBODIMENTS

In an embodiment of the invention the stored gas contains hydrocarbons and/or water, and combinations thereof. The stored gas contains preferably gas selected from a group comprising of methane, ethane, butane, hydrogen, propane, propene, ethylene, water and/or methane, and combinations thereof, in particular natural gas. In particular preferred is stored gas which comprises methane as a main component.

Fuels can be stored in the sorption store of the invention and be provided by desorption to an internal combustion engine or a fuel cell for example. Methane is particularly suitable as fuel for internal combustion engines. Fuel cells are preferably operated using methanol or hydrogen.

In a preferred embodiment of the invention the gas adsorbent medium is a porous and/or microporous solid.

Generally, a variety of materials can be applied and be combined for gas adsorbent media, independently of their characteristics regarding their impact on the gas flow in the vessel, their packing density and their heat capacity. The adsorbent media are preferably applied as pellets but can likewise be applied as powder, monolith or in any other form.

In a particularly preferred embodiment, the at least one gas adsorbent medium is selected from a group comprising activated charcoals, zeolites, activated alumina, silica gels, open-pore polymer foams and metal-organic frameworks, and combinations thereof.

Various materials are suitable as adsorbent medium for the sorption store. The adsorbent medium preferably comprises activated charcoals, zeolites, activated alumina, silica gels, open-pore polymer foams and metal-organic frameworks (MOFs). The adsorption medium preferably comprises metal-organic frameworks (MOFs).

Zeolites are crystalline aluminosilicates having a microporous framework structure made up of AlO₄ and SiO₄ tetrahedra. Here, the aluminum and silicon atoms are joined to one another via oxygen atoms. Possible zeolites are zeolite A, zeolite Y, zeolite L, zeolite X, mordenite, ZSM (Zeolites Socony Mobil) 5 or ZSM 11. Suitable activated carbons are in, particular, those having a specific surface area above 500 m²g⁻¹, preferably about 1500 m²g⁻¹, very particularly preferably above 3000 m² g⁻¹. Such an activated carbon can be obtained, for example under the name Energy to Carbon or MaxSorb.

Metal-organic frameworks (MOF) are known in the prior art and are described for example in U.S. Pat. No. 5,648,508, EP-A 0 700 253, M. O'Keeffe et al., J. Sol. State Chem., 152 (2000), pages 3 to 20, H. Li et al., Nature 402, 1(1999), page 276, M. Eddaoudi et al., Topics in Catalysis 9, (1999), pages 105 to 111, B. Chen et al., Science 291, (2001), pages 1021 to 1023, DE-A 101 11 230, DE-A 10 2005 053430, WO-A 2007/054581, WO-A 2005/049892 and WO-A 2007/023134. The metal-organic frameworks (MOF) mentioned in EP-A 2 230 288 A2 are particularly suitable for sorption stores. Preferred metal-organic frameworks (MOF) are MIL-53, Zn-tBu-isophthalic acid, Al-BDC, MOF 5, MOF-177, MOF-505, MOF-A520, HKSUST-1, IRMOF-8, IRMOF-11, Cu-BTC, Al-NDC, Al-AminoBDC, Cu-BDC-TEDA, Zn-BDC-TEDA, Al-BTC, Cu-BTC, Al-NDC, Mg-NDC, Al-fumarate, Zn-2-methylimidazolate, Zn-2-aminoimidazolate, Cu-biphenyldicarboxylate-TEDA, MOF-74, Cu-BPP, Sc-terephthalate. Greater preference is given to MOF-177, MOF-A520, KHUST-1, Sc-terephthalate, Al-BDC and Al-BTC.

Apart from the conventional method of preparing the MOFs, as described, for example, in U.S. Pat. No. 5,648,508, these can also be prepared by an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Particularly suitable materials for the adsorption in sorption stores are the metal-organic framework materials MOF A520, MOF Z377 and MOF C300.

MOF A 520 is based on aluminium fumarate. The specific surface area of a MOF A520, measured by porosimetry or nitrogen adsorption, is typically in the range from 800 m̂2/g to 2000 m̂2/g. The adsorption enthalpy of MOF A520 with regard to natural gas amounts to 17 kJ/mol. Further information on this type of MOF may be found in “Metal-Organic Frameworks, Wiley-VCH Verlag, David Farrusseng, 2011”. The pellets have all a cylindrical shape with a length of 3 mm and diameter of 3 mm. Their permeability is preferably between 1·10̂-15 m̂2 and 3·10̂-3 m̂2. The porosity of the bed, which is defined as the ratio of the void volume between the pellets to the total volume of the vessel without considering the free volume within the pellets, is at least 0.2, for example 0.35.

MOF Z377, in literature also referred to as MOF type 177, is based on zinc-benzene-tribenzoate. The specific surface area of a MOF Z377, measured by porosimetry or nitrogen adsorption, is typically in the range from 2000 m̂2/g to 5000 m̂2/g. The MOF Z377 typically posses an adsorption enthalpy between 12 kJ/mol and 17 kJ/mol with respect to natural gas. MOF C300 is based on copper benzene-1,3,5-tricarboxylate and for example commercially available from Sigma Aldrich under the tradename Basolite® C300.

In a preferred embodiment of the invention, the adsorbent medium is present as a bed of pellets and the ratio of the permeability of the pellets to the smallest pellet diameter is at least between 1*ê-11 m̂2/m and 1*ê-16 m̂2/m, preferably between 1*ê-12 m̂2/m and 1*ê-14 m̂2/m, and most preferably 1*ê-13 m̂2/m. The rate at which the gas penetrates into the pellets during filling depends on the rapidity with which the pressure in the interior of the pellets becomes the same as the ambient pressure. With decreasing permeability and increasing diameter of the pellets, the time for this pressure equalization and thus also the loading time of the pellets increases. This can have a limiting effect on the overall process of filling and discharging.

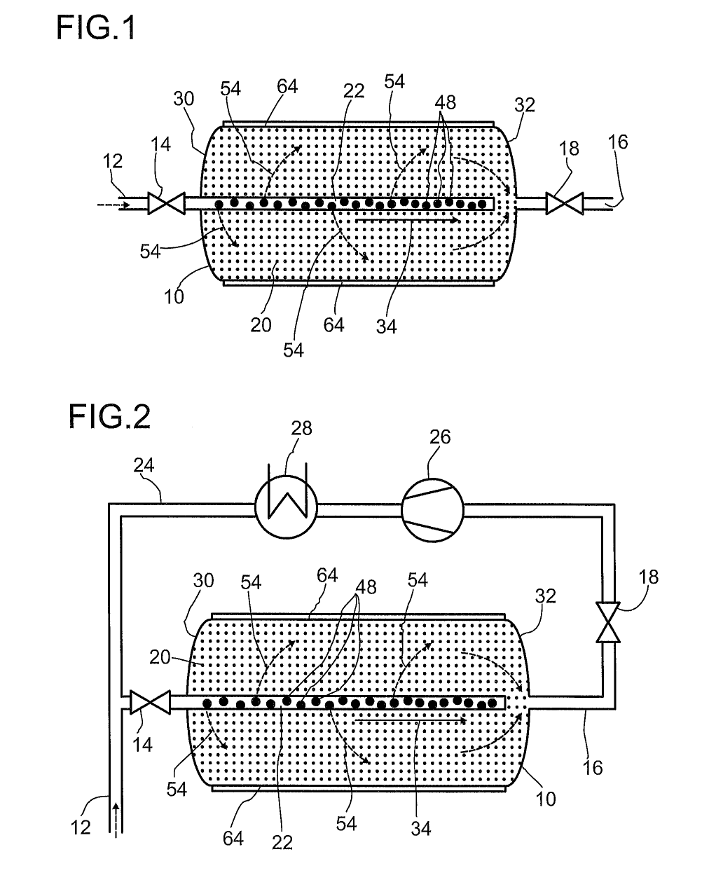

FIG. 1 shows a first embodiment of the ANG-sorption store.

The ANG-sorption store has a circular cross-section and is labeled with reference number 10. Said ANG-sorption store 10 includes an inlet 12, an inlet valve 14 as well as an outlet 16 and an outlet-valve 18. Said ANG-sorption store 10 is filled with at least one adsorption medium 20, such as metal organic frameworks (MOF). According to FIG. 1, said ANG-sorption store 10 is arranged substantially in horizontal direction. The interior of the said ANG-sorption store 10 is defined by a first end face 30 and a second end face 32 as well as a wall 64, extending in circumferential direction according to FIG. 1. Said filling device 22 arranged in the center thereof and extending in axial direction 34, i.e. in axial direction of the ANG-sorption store 10 and has a number of orifices 48, through each of which gas jets 54 of a natural gas, such as CH₄, are ejected into the interior, i.e. into the at least one adsorption material 20, being present in the ANG-sorption store 10. According to FIG. 1, the arrows symbolize the movement of the gaseous medium within the ANG-sorption store 10. Gas is fed at inlet 12 into the interior of said ANG-sorption store 10 by means of the orifices 48, on the circumference of the tubular-shaped filling device 22 into the at least one adsorption medium 20. Part of the gas is being adsorbed by the at least one adsorption medium 20, the remainder of it leaves the ANG-sorption store 10. According to the present invention, a more uniform fluid dynamics and a more uniform temperature distribution within the interior of the ANG-sorption store 10 is achieved.

FIG. 2 shows a further embodiment of the ANG-sorption store, being embedded in a circulation circuit.

According to FIG. 2, outlet 16 is provided with an outlet-valve 18 connected to a compressor 26. The circulation circuit 24 further comprises a heat exchanger 28 to cool the medium, i.e. the natural gas circulated within the circulation circuit 24 according to FIG. 2. By means of inlet 12 only the amount of gas is provided which is adsorbed at the at least one adsorption medium 20 present within the ANG-sorption store 10 according to FIG. 2. The embodiment according to FIG. 2 is very advantageous for vehicle applications since no external gas is necessary to establish a continuous circulation of gas through the interior of said ANG-sorption store 10. According to the embodiment given in FIG. 2, filtering elements are not necessary, which however are present at fuel stations to prevent contamination of the natural gas to be absorbed within said sorption store 10.

According to FIG. 2, the ANG-sorption store 10 comprises said two end faces 30, 32, respectively, the filling device 22 extending substantially in axial direction 34 and having a number of orifices 48 distributed in axial direction thereof. Out of each of said orifices 48, present at the circumference of the mantle of the filling device 22, emerging gas jets 54 are ejected into the at least one absorption medium 20 present within the ANG-sorption store 10 according to FIG. 2. A cooling is provided by a double-walled wall 64 of the generally cylindrically shaped ANG-sorption store 10 according to the present invention.

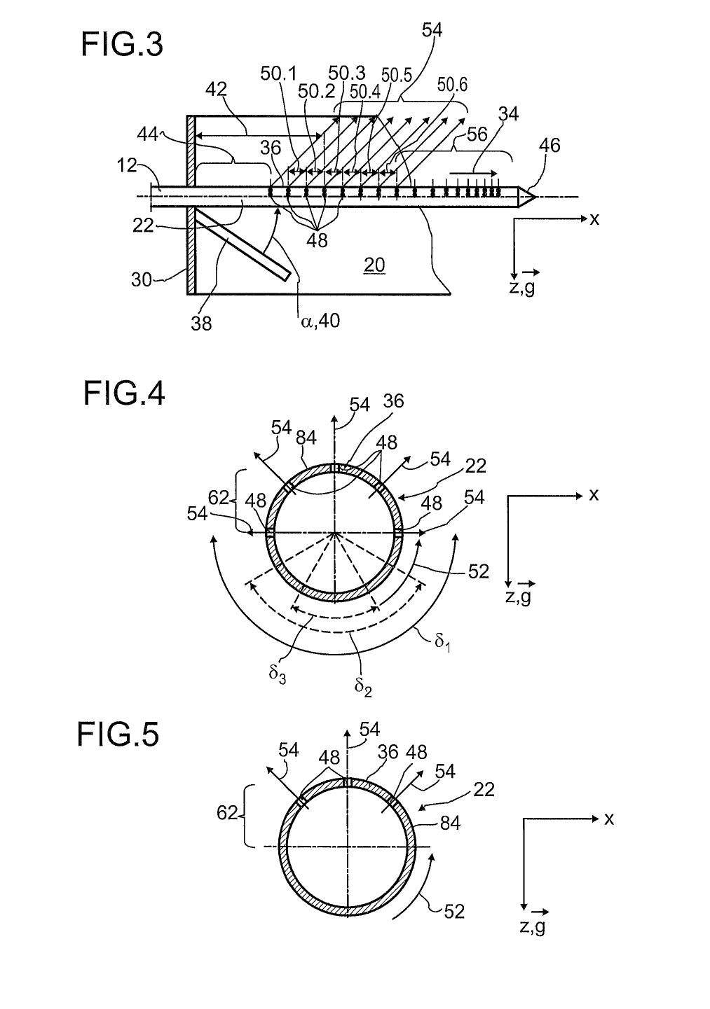

FIG. 3 shows the filling device in greater detail being fixed to one end face of the ANG-sorption store.

According to FIG. 3, said filling device 22 being of tubular shape is fixed to the first end face 30 of the ANG-sorption store 10. Through inlet 12 natural gas to be adsorbed is fed to the hollow interior of the filling device 22. The filling device 22 according to the present invention extends in axial direction 64 into the interior of said ANG-sorption store 10, filled with at least one adsorption medium 20, such as metal organic frameworks (MOF). Said filling device 22 comprises a mantle 36 defining a hollow interior. Said filling device 22 comprises a tip 46. The tubular-shaped filling device 22 comprises a first upper part 62 and a lower part 63. Whereas the upper part of the tubular-shaped filling device 22 is equipped with a number of orifices 48, there are no orifices 48 on the circumference of the lower half 63 of the tubular-shaped filling device 22 within an angle between 30° and 180°, preferably 120°, depending on the porosity of the at least one adsorption medium/adsorption media chosen and present in the sorption store 10. Consequently, emerging gas jets 54 are only ejected into the upper part or the upper region of the at least one adsorption medium 20 present in the ANG-sorption store 10 according to the present invention. From FIG. 3 it becomes clear that the orifices 48, present on the circumference of the upper part 62 of the tubular-shaped filling device according to the present invention, begin after a first length 44 of about 20 cm to 30 cm. In a very advantageous embodiment, the orifices 48 present in the upper part 62 of the tubular-shaped filling device 22 begin after the half-length 42.

As shown in FIG. 3, the orifices 48 are arranged in circumferential direction 52 on the mantle 62 in rows adjacent to one another. Said rows of orifices 48 may be arranged on the mantle 62 of the filling device 22 in varying distances 50.1, 50.2, 50.3, 50.4, 50.5 and 50.6. This means that the adjacent rows of orifices 48 come closer with increasing length of the filling device 22 in axial direction 34. That means a larger amount of natural gas is expelled in the middle section of the ANG-sorption store 10 according to the present invention, providing for a more homogeneous temperature distribution within the ANG-sorption store 10.

Alternatively, said rows of orifices 48 present on the upper part 62 of the filling device 22 according to the present invention may be arranged in equidistance, i.e. the distance between each row is identical when seen in axial direction 34 of the filling device 22 as to the first end face 30 of the ANG-sorption store 10 according to the present invention.

According to FIG. 3, below the tubular-shaped filling device 22, a temperature sensor 38 is arranged. The temperature sensor 38 is arranged in an inclination angle a, see reference number 40. By means of the temperature sensor 38, the temperature below the filling device 22, by means of which natural gas jets 54 are expelled into the upper portion of the ANG-sorption store 10, is measured.

From FIG. 3 it becomes clear that at the lower part 63 of the tubular-shaped filling device 22, no gas jets 54 of natural gas are expelled in direction of the bottom of the ANG-sorption store 10 according to the present invention. In FIG. 3, angle areas δ₁, δ₂ and δ₃ are shown, within which no orifices 48 are present in the lower part 63 of the filling device 22.

In FIG. 4, a cross-section of the filling device according to FIG. 3 is given in a larger scale:

According to FIG. 4, in the upper part 62 of the tubular-shaped filling device 22, a number of orifices 48 are manufactured. In the example according to FIG. 5, orifices 48 are arranged in circumferential direction 52 on the surface of the upper part 62 of the filling device 22 according to the present invention. Through each of said orifices 48, a gas jet 54 of natural gas is ejected into the at least one adsorption medium 20, such as metal organic framework (MOF), present in the interior of the ANG-sorption store 10. An outer surface of the mantle 63 of the filling device 22 according to the present invention is labeled with reference number 84.

FIG. 5 shows a cross-section through a tubular-shaped filling device according to FIG. 3 having only three orifices 48 arranged in the upper part 62. Instead of five orifices 48, shown in the embodiment according to FIG. 4, the embodiment according to FIG. 5 comprises only three orifices 48 present in the upper part 62 of the filling device 22 according to the present invention. Thus, only three-gas jets 54 of natural gas are ejected out of the filling device 22, substantially into vertical direction.

With respect to FIGS. 4 and 5, respectively, the number of orifices 48 present in the upper part 62 of the filling device 22 depends on the size of the ANG-sorption store 10 and the material of the at least one adsorption medium 20 present within the ANG-sorption store. The at least one sorption material is shaped as pellets, having a geometry of a cylinder, a ball or a rectangle or the like. The geometry of the pellets defines the pressure loss within the sorption store 10. Given a porosity, which is defined as the ratio between the hollow space between the pellets with respect to the entire volume of the sorption store less than 0.3, only the upper part 62 of the filling device 22 is provided with orifice in circular shape or in slot shape. Given a porosity between 0.5 and 0.3, it is very beneficial that the lower circumference, i.e. the lower part 63 of the filling device 22 according to the present invention is free of orifices 48 within an angle of 120° and 180°. Provided the porosity is less than 0.3, an angular area of about 60° of the circumference of the lower part 63 should be free of orifices 48 which however are present on the upper part 62 of the tubular-shaped filling device 22.

The orifices shown in the cross-section according to FIGS. 4 and 5 as discussed above may be shaped as holes or as slots, depending on the material used for the filling device and depending on manufacturing options.

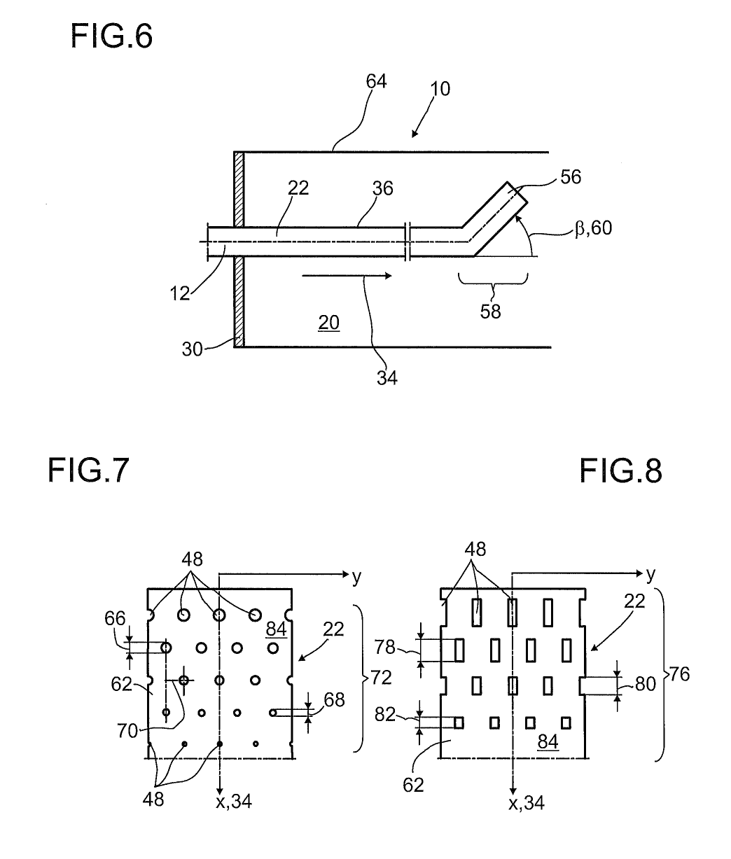

FIG. 6 shows an embodiment of the filling device of the present invention for use in passenger vehicles.

In contrast to the filling devices as discussed above in connection with FIGS. 3, 4 and 5, respectively, the mantle 36 of the filling device 22 according to FIG. 6 does not have orifices 48 present on its upper part 62. Instead, the filling device 22 in the embodiment according to FIG. 6 comprises an open-end section 56. The open-end section 56 comprises only one opening, which is arranged in a bent section 58. The bent section 58 of the tubular-shaped filling device 22 according to the embodiment given in FIG. 6 is directed in vertical direction about a bending angle 60, between 45° and 90°, preferably about 60°. The bending angle is labeled with reference number 60, β. The embodiment of the filling device 22 according to FIG. 6 is very advantageous for smaller ANG-sorption stores 10 for passenger vehicles, having a volume of about 100 l. According to the present invention, the orifices 48 may be arranged in patterns on a surface 84 of the upper part 62 of the tubular-shaped filling device 22 according to the present invention. This is best shown in FIGS. 7 and 8, respectively.

According to FIG. 7, an orifice pattern 72 is shown in top view, said orifices 48 according to the orifice pattern 72 being embodied as holes. Said holes shown in FIG. 7 may have a first diameter 66 which extends a second diameter 68 according to FIG. 7. As is best shown in the top view according to FIG. 7, said hole-shaped orifices 48 are arranged in rows in circumferential direction 52 on the upper part 62 of the tubular-shaped filling device 22. In FIG. 6, it is shown that single hole-shaped orifices 48 within the orifice pattern 72 may have an offset 70 with respect to adjacent rows or hole-shaped orifices 48. As shown in FIG. 7, the diameter of the hole-shaped orifices 48 increases when seen in axial direction 34. In a non-illustrated alternative embodiment, the diameters of the hole-shaped orifices may increase in axial direction of the upper half 62 of the filling device 22 starting from the half-length 42 of the tubular-shaped filling device 22 as shown in FIG. 3.

In this alternative embodiment, a half-length starting from half-length 42 on the mantle 36 of the filling device 22, the hole-shaped orifices 58 may have a smaller, i.e. second diameter 68, the diameter increasing in adjacent rows of hole-shaped orifices 48 when seen in axial direction 34.

In FIG. 8, a further arrangement of orifices is shown, said orifices having a slot-like shape. A slotted pattern 76 according to FIG. 8 comprises likewise rows of slot-like orifices 48 arranged in circumferential direction 52 on the upper half/ upper shell 62 of the tubular-shaped filling device 22 according to the present invention. According to the slotted pattern 76 given in the top view according to FIG. 8 in axial direction 34, a slot length 78, 80, 82 varies when seen in axial direction. As already shown in FIG. 7, slot-shaped orifices 48 may have an offset 70 with respect to one another. The embodiment given in FIG. 8, the slot-length 78, 80, 82 decreases in axial direction 34, in a non-illustrated embodiment given in a separate drawing, beginning with one third or one half 42 (see FIG. 3), said slotted orifice pattern 76 may comprise slots of the third length 80, i.e. the shortest length, arranged in rows in circumferential direction 52, followed by a row of slot-shaped orifices 48 having second slot-length 72 followed by a row of slot-shaped orifices 48 in the first slot-length 78. According to this non-illustrated embodiment, the slot-length increases when seen in axial direction 34 of the tubular-shaped filling device 22 according to the present invention.

Preferably, the slot-length 78, 80, 82 or the diameter 66, 78, respectively, of the orifices 48 should be less than the size of the pellets of the at least one adsorption material 20 present in the interior of the ANG-sorption store 10 according to the present invention. This ensures that no particle of the adsorption material 20 adds into the hollow interior of the filling device 22. The area of the orifices 48 deployed with the numbers of orifices 48 would equal the area of the outlet 16. The area of the outlet 16 and the area of the inlet 12 of the ANG-sorption store 10 should be sufficient enough to keep the velocities on a low level and to improve the pressure loss.

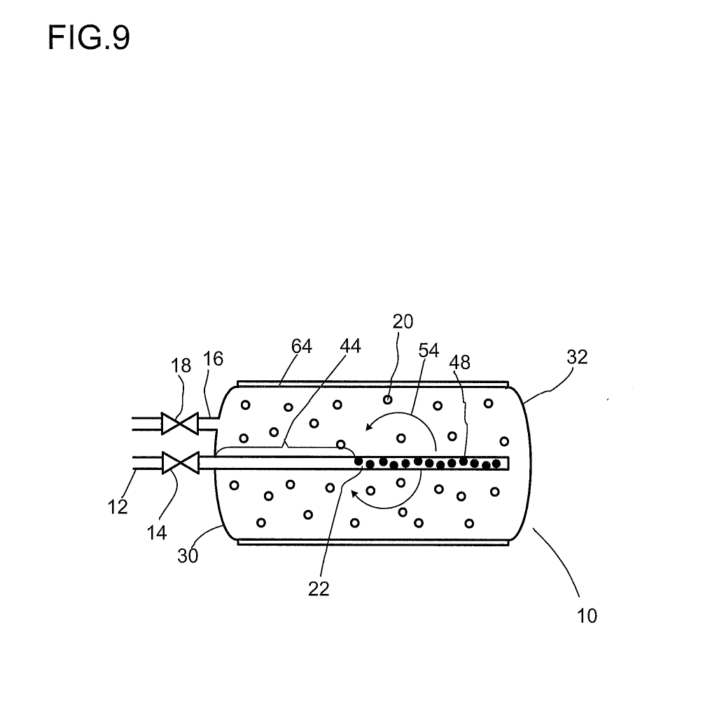

FIG. 9 shows an embodiment of an ANG-sorption store with an inlet 12 and an outlet 16 on the same end face.

According to the embodiment illustrated by FIG. 9 the inlet 12 with the inlet-valve 14 and the outlet 16 with the outlet-valve 18 are both located on the first end face 30. Comparable to FIG. 2, a circulation circuit 24 connecting the outlet-valve 18 with the inlet-valve 14 can be effectuated. In case the inlet 12 and the outlet 18 are located on the same end face of the sorption store 10, the first-length 44 of the filling pipe 22 measures preferably between 25% and 75%, in particular preferably between 40% and 60% and most preferably 50%, by length of the total length of the filling pipe 22 and preferably the orifices 48, present on the circumference of the upper part 62 of the tubular-shaped filling pipe 22 according to the present invention, begin after the first length 44 seen in axial direction.

### LIST OF REFERENCE NUMERALS

10 ANG-sorption store
12 inlet
14 inlet-valve
16 outlet
18 outlet-valve
20 adsorption medium
22 filling device, filling pipe
24 circulation circuit
26 compressor
28 heat exchanger
30 first end face
32 second end face
34 x-direction, axial direction
36 mantle
38 temperature sensor
40 inclination angle, α
42 half-length
44 first-length
46 tip
48 orifices
50.1 to 50.6 distances
52 circumferential direction
54 emerging gas jets
56 end section
58 bent section
60 bending angle β
62 upper part
63 lower part
64 double-wall of sorption tank
66 first diameter of orifice
68 second diameter of orifice
70 offset of orifices
72 orifice pattern
74 interior of ANG-sorption store
76 slotted pattern
78 first slot-length
80 second slot-length
82 third slot-length
84 outer surface of mantle

1.-18. (canceled)

19. A filling device for an ANG-sorption store containing at least one adsorption medium, said filling device being of tubular shape, having a mantle defining a hollow interior, orifices in said mantle, said ANG-sorption store substantially mounted horizontally, wherein said orifices are arranged on an upper part of said mantle of the filling device extending in axial direction through said ANG-sorption store.

20. The filling device according to claim 19, wherein a lower part of said filling device within an angle between 30° to 180° is free of orifices, thus preventing gas jets directed to the bottom of said sorption store, said angle chosen depending on the porosity of the at least one sorption material.

21. The filling device according to claim 19, wherein said orifices are arranged on said mantle in axial direction thereof.

22. The filling device according to claim 19, wherein said orifices are arranged equidistant with respect to one another in axial direction.

23. The filling device according to claim 19, wherein said orifices are arranged in varying distances in axial direction with respect to one another.

24. The filling device according to claim 19, wherein said orifices are holes or slots.

25. The filling device according to claim 19, wherein said filling device extends from an end face, respectively of said ANG-sorption store.

26. The filling device according to claim 19, wherein said orifices have an identical geometry.

27. The filling device according to claim 19, wherein said orifices are arranged in rows about a circumference of said mantle, each row having at least three orifices.

28. The filling device according to claim 19, wherein said orifices, arranged in axial direction on said mantle, have decreasing or increasing diameters seen in axial direction.

29. The filling device according to claim 19, wherein said orifices form an orifice pattern on said mantle, orifices in adjacent rows of orifices having an offset with respect to one another.

30. The filling device according to claim 19, wherein said orifices are arranged in a slotted pattern on said mantle, said orifices having different slot-lengths.

31. The filling device according to claim 19, wherein said orifices, arranged in axial direction on said mantle, have a decreasing or increasing slot-length seen in axial direction.

32. An ANG-sorption store containing at least one adsorption material equipped with the filling device according to claim 19.

33. The ANG-sorption store according to claim 32, wherein said ANG-sorption store has a substantially cylindrical shape.

34. The ANG-sorption store according to claim 32, wherein said filling device is arranged a central access as symmetry access of said ANG-sorption store.

35. The ANG-sorption store according to claim 32, wherein an inlet is located at a first end face and an outlet is located at a second end face and wherein said orifices have decreasing diameters seen in axial direction or wherein said orifices are arranged in increasing distances in axial direction with respect to one another or wherein said orifices have a decreasing slot-length seen in axial direction.

36. The ANG-sorption store according to claim 32, wherein an inlet and an outlet are located at one end face, respectively, and wherein the orifices begin after a first length measuring between 40% and 60% by length of the total length of the filling device seen in axial direction.

37. The filling device according to claim 19, wherein a lower part of said filling device within an angle of 30° to 120°, is free of orifices, thus preventing gas jets directed to the bottom of said sorption store, said angle chosen depending on the porosity of the at least one sorption material.
